(19) United States
(12) Patent Application Publication
(10) Pub. No.: US 2002/0184958 A1
(43) Pub. Date: Dec. 12, 2002

(54) Driving device for an electrically driven telescoping cylinder

(76) Inventor: Chun-Ru Meng, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/878,301

(22) Filed: Jun. 12, 2001

(51) Int. Cl. F16H 3/06; F16H 25/20

(52) U.S. Cl. 74/89.34; 74/89.23

(57) ABSTRACT

A driving device for an electrically driven telescoping cylinder has a motor, a shaft connector, a positioning base and a sensor. The connector is rotatably attached to the motor. The connector includes a driving base, a driven base and a magnet. The driving base is connected to the shaft. The driven base is attached to the driving base and connects with the threaded drive rod of the electrically driven telescoping cylinder. The magnet is mounted around the driving base. The positioning base is mounted in the housing of the electrical cylinder to support the connector. The sensor is secured in the positioning base to detect variations in magnetic field of the magnet. Consequently, the revolutions of the shaft of the motor can be detected. A conventional controller is not needed, and the size of the electrically driven telescoping cylinder can be reduced.

### BACKGROUND OF THE INVENTION

1. Field of the Invention

The present invention relates to a driving device, and more particularly to a driving device for an electrically driven telescoping cylinder and can reduce the size of the cylinder.

2. Description of Related Art

With reference to FIGS. 4 and 5, a conventional electrically driven telescoping cylinder in accordance with the prior art comprises a tubular housing (50), a driving device, a threaded drive rod (62) and an extension rod (63). A front cover (51) and a rear cover (52) are attached to opposite ends of the housing (50) to close the housing (50). The driving device is mounted in the housing (50). The driving device substantially comprises a motor (60) and a shaft connector (61). The motor (60) is mounted in the housing (50) and has a rotating shaft (600). The shaft connector (61) is attached to the shaft (600) to rotate with the shaft (600). The threaded drive rod (62) is connected to the shaft connector (61), such that the threaded drive rod (62) is rotated by the motor (60) through the connector (61). The extension rod (63) is screwed onto the threaded drive rod (62) and extends out from the housing (50). Consequently, the extension rod (63) will move relative to the housing (50) when the threaded drive rod (62) rotates.

The conventional connector (61) in accordance with the prior art comprises a driving base (610) and a driven base (611). The driving base (610) is attached to the shaft (600) of the motor (60) and rotates with the shaft (600). The driven base (611) is attached to the driving base (610). In practice, multiple threaded holes (612) are defined through the driving base (610). A blind hole (614) is defined in the driven base (611) to align with each threaded hole (612) in the driving base (610). A bolt (617) is screwed into each threaded hole (612) in the driving base (610) and extends into the corresponding blind hole (614) in the driven base (611). Consequently, the driven base (611) is connected to the driving base (610) by the bolts (617) and rotates with the driven base (610). A threaded hole (618) is defined in the driven base (611) to screw onto a threaded stub (622) formed on the threaded drive rod (62). Accordingly, the threaded drive rod (62) will rotate with the shaft (600) by the transmission of the shaft connector (61).

However, because the conventional connector (61) is not supported, the connector (61) will easily vibrate when the connector (61) rotates with the motor shaft (600). In addition, because the vibration occurring in the motor (60) cannot be absorbed, loud noise easily results.

In addition, a sensor (70) to count the revolutions of the shaft (600) of the motor (60) is attached to the motor (60). The sensor (70) is electrically connected to a controller or a computer that is also electrically connected to the motor (60), such that the travel of the extension rod (63) can be computed and controlled based on the sensed revolutions of the shaft (600). However, because the conventional sensor (70) is an additional structure attached to the motor (60), a large space is needed to mount the motor (60) with the conventional sensor (70). The size of the electrically driven telescoping cylinder is enlarged.

To overcome the shortcomings, the present invention tends to provide an improved driving device to mitigate or obviate the aforementioned problems.

### SUMMARY OF THE INVENTION

The main objective of the invention is to provide an improved driving device for an electrically driven telescoping cylinder that can reduce the size of the electrically driven telescoping cylinder. The driving device has a motor, a shaft connector, a positioning base and a sensor. The shaft connector is attached to the rotating shaft of the motor. The connector includes a driving base, a driven base and a magnet. The driving base is connected to the shaft of the motor. The driven base is attached to the driving base and connects with the threaded drive rod of the electrically driven telescoping cylinder. The magnet is mounted around the outer periphery of the driving base. The positioning base is mounted in the housing of the electrically driven telescoping cylinder to rotatably receive the shaft connector in the positioning base to support the connector. The sensor is secured in the positioning base and faces the magnet to detect the magnetic variations of the magnet. Consequently, the revolutions of the shaft of the motor can be sensed, and the travel of the extension rod can also be calculated and controlled. A conventional controller does not need to be attached to the motor so the size of the electrically driven telescoping cylinder can be reduced.

The other objective of the invention is to provide an improved driving device that can absorb the vibrations occurring during the operation. A cylindrical shock absorber is mounted around the motor. A flat shock absorber is attached to the motor and abuts the positioning base. A first shock absorber is received in the driven base and encloses each bolt inserted into the driven base and mounted on the driving base. A second shock absorber is received in the positioning base and encloses each post extending into the positioning base and mounted on the motor. Consequently, vibrations occurring during the operation of the driving device can be absorbed and noise is avoided.

Other objects, advantages and novel features of the invention will become more apparent from the following detailed description when taken in conjunction with the accompanying drawings.

### BRIEF DESCRIPTION OF THE DRAWINGS

FIG. 1 is an exploded perspective view of a driving device in accordance with the present invention for an electrically driven telescoping cylinder;

FIG. 2 is an exploded perspective view of the shaft connector in the driving device in FIG. 1;

FIG. 3 is a side plan view in partial section of the electrically driven telescoping cylinder with the driving device in FIG. 1;

FIG. 4 is a side plan view in partial section of an electrically driven telescoping cylinder with a conventional driving device in accordance with the prior art; and

FIG. 5 is an exploded perspective view of the conventional driving device in FIG. 4.

### DETAILED DESCRIPTION OF PREFERRED EMBODIMENT

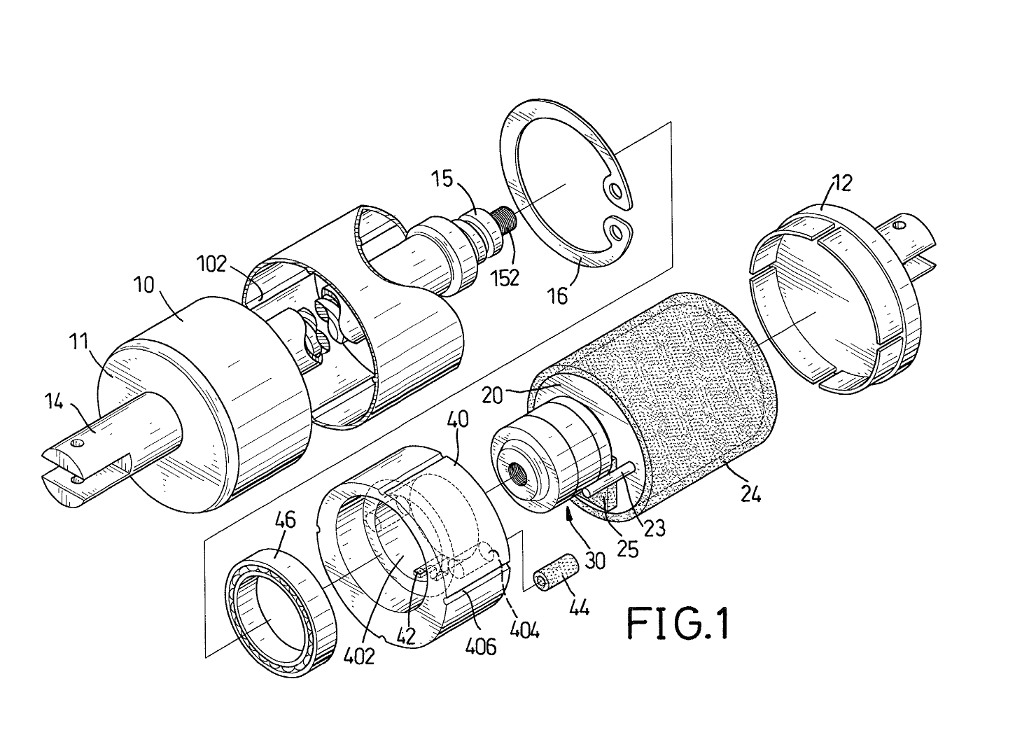

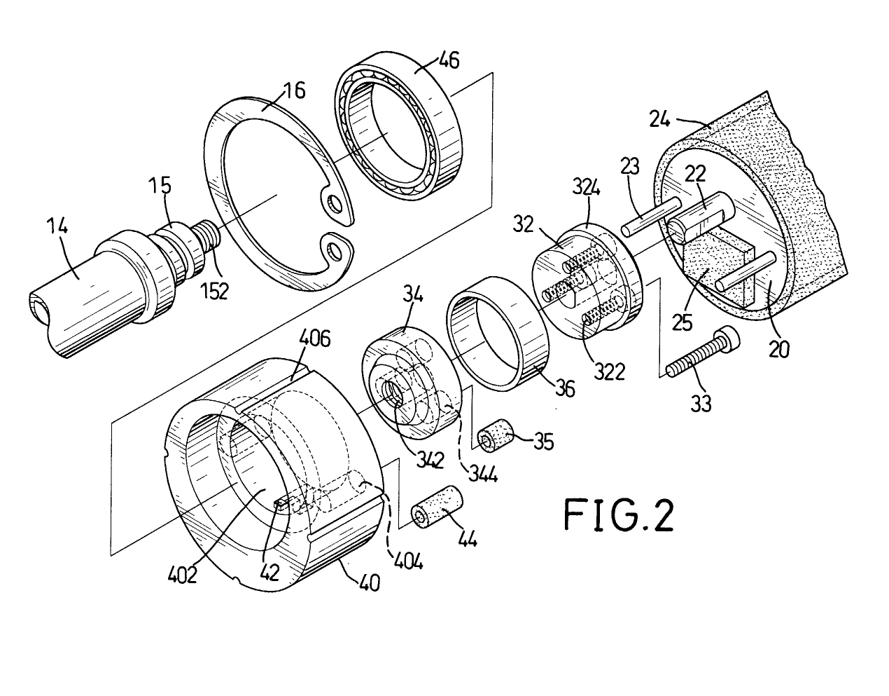

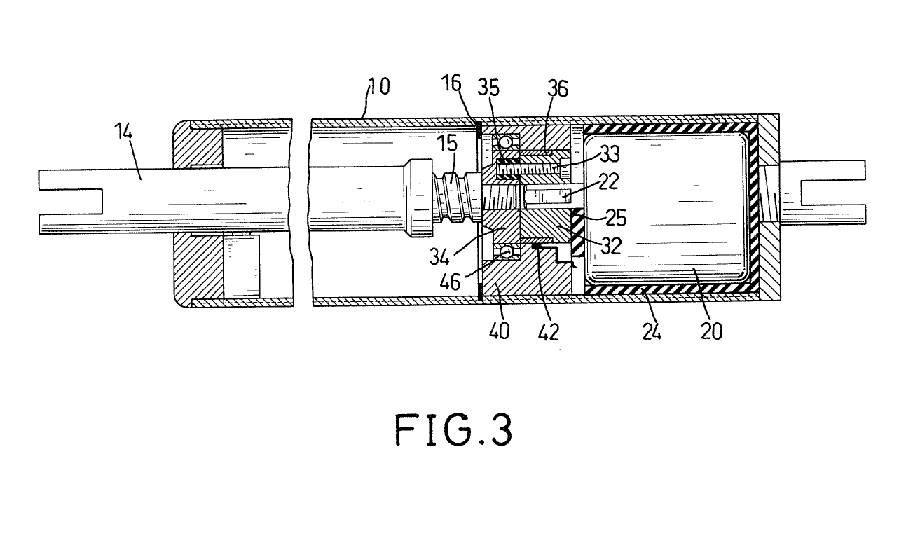

With reference to FIGS. 1 to 3, an electrically driven telescoping cylinder comprises a tubular housing (10), a driving device, a threaded drive rod (15) and an extension rod (14). A front cover (11) and a rear cover (12) are attached to opposite ends of the housing (10) to close the housing (10). The driving device is mounted in the housing (10). The threaded drive rod (15) is attached to and actuated by the driving device. The extension rod (14) is screwed onto the threaded drive rod (15) and extends out from the housing (10) through the front cover (11).

The driving device in accordance with the present invention comprises a motor (20), a shaft connector (30) and a positioning base (40). The motor (20) is mounted in the housing (10). A rotating shaft (22) rotatably extends from the motor (20). The shaft connector (30) is attached to the shaft (22) to rotate with the shaft (22). The shaft connector (30) includes a driving base (32), a driven base (34) and a magnet (36). The driving base (32) is attached to the shaft (22) of the motor (20). The driven base (34) is attached to the driving base (32) to rotate with the driving base (32). A threaded hole (342) is defined in one side of the driven base (34) to screw onto a threaded stub (152) on the threaded drive rod (15). Consequently, the threaded drive rod (15) is securely attached to the driven base (34) and rotates with the driven base (34).

Multiple threaded holes (322) are defined through the driving base (32). A blind hole (344) to correspond and align with each threaded hole (322) in the driving base (32) is defined in the driven base (34). A bolt (33) is screwed into each threaded hole (322) in the driving base (32) and extends into the corresponding blind hole (344) in the driven base (34). Accordingly, the driven base (34) is attached to and rotates with the driving base (32). A shock absorber (35) is mounted in each blind hole (344) and encloses the bolt (33) inserted into the blind hole (344). The vibrations occurring between the driving base (32) and the driven base (34) can be absorbed by the shock absorbers (35).

The magnet (36) is pressed onto the driving base (32) to rotate with the driving base (32). The magnet (36) has multiple opposite magnetic poles alternatively arranged on the outer periphery of the magnet (36). A shoulder (324) with an outer diameter larger than that of the driving base (32) is formed on one end of the driving base (32) to abut the magnet (36), such that the magnet (36) can be held in position.

The positioning base (40) is mounted in the housing (10). An annular groove (not numbered) is defined around the inner surface of the housing (10). A C-shaped or E-shaped fastener (16) is mounted in the groove to abut one end of the positioning base (40), such that the positioning base (40) and the motor (20) are firmly held between the rear cover (12) and the fastener (16). Multiple longitudinal keyways (406) are defined in the outer periphery of the positioning base (40). Longitudinal keys (102) corresponding to the keyways (406) in the positioning base (40) are defined on the inner surface of the housing (10) to engage with the keyways (406) in the positioning base (40). Accordingly, the positioning base (40) will not rotate relative to the housing (10) due to the engagement between the keyways (406) and the corresponding keys (102).

A central hole (402) is defined through the positioning base (40) to receive the shaft connector (30). A bearing (46) is mounted in the central hole (402) of the positioning base (40) to engage with the driven base (34) of the connector (30). Consequently, the shaft connector (30) can rotate freely relative to the positioning base (40). Because the shaft connector (30) is mounted and supported in the positioning base (40), the vibration of the connector (30) can be avoided.

At least one blind hole (404) is defined in the side of the positioning base (40) facing the motor (20). A post (23) protrudes from the motor (40) and extends into each blind hole (404) in the positioning base (40) to keep the motor (20) from rotating inside the tubular housing (10). A shock absorber (44) is mounted in each blind hole (404) in the positioning base (40) and encloses the post (23) extending into the corresponding blind hole (404). In addition, a flat shock absorber (25) is attached to the motor (20) and abuts the positioning base (40), and a cylindrical shock absorber (24) is mounted around the motor (20). The vibrations generated by the motor (20) can be absorbed by the shock absorbers (24, 25, 44), and noise can be avoided.

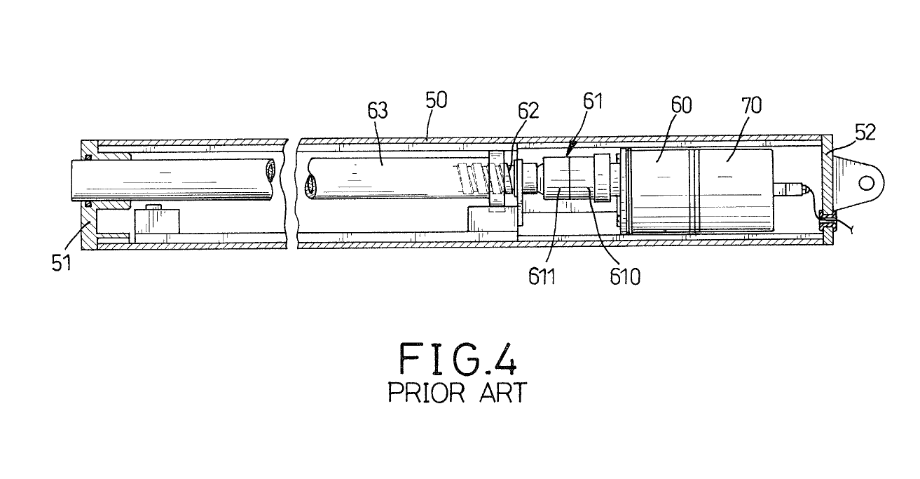

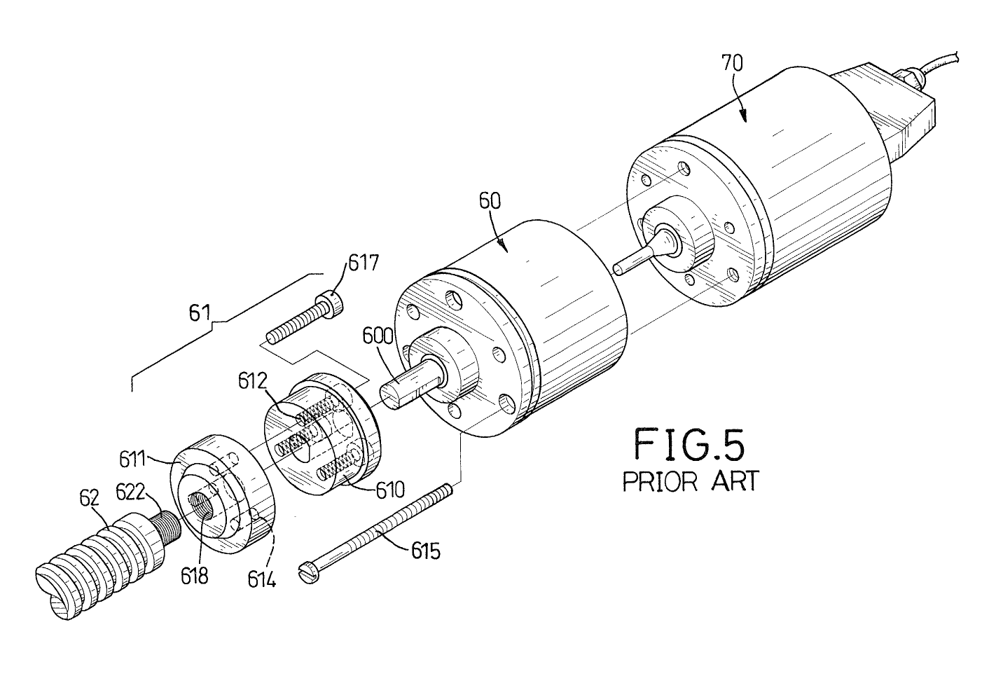

A sensor (42) is secured in the positioning base (40) and faces the magnet (36). The sensor (42) is electrically connected to a controller or a computer that is also electrically connected to the motor (20). Because the magnet (36) has multiple opposite magnetic poles alternatively arranged on the outer periphery of the magnet (36), the sensor (42) can detect the variations in the magnetic field of the magnet (36) when the magnet (36) rotates. The revolutions of the shaft (22) of the motor (20) are detected and counted. Furthermore, the distance the extension rod (14) travels is also calculated and controlled. Because the conventional detector (70) as shown in FIGS. 4 and 5 does not need to be attached to the motor (20), the size of the electrically driven telescoping cylinder can be reduced.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A driving device for a electrically driven telescoping cylinder having a tubular housing, an extension rod movable extending out from the housing and a threaded drive rod screwed into the extension rod, the driving device comprising:
a motor with a rotating shaft rotatably extending from the motor;
a cylindrical shock absorber mounted around the motor to absorb vibrations generated by the motor;
a shaft connector attached to the shaft of the motor to rotate with the shaft and having:
a driving base connected to the shaft;
a driven base attached to the driving base and adapted to connect with the threaded drive rod; and
a magnet mounted around an outer periphery of the driving base and having multiple opposite magnetic poles alternatively arranged on an outer periphery of the magnet.;
a positioning base for rotatably mounting the shaft connector in the positioning base to support the connector; and
a sensor secured in the positioning base and facing the magnet to detect variations in the magnetic field of the magnet.

2. The driving device as claimed in claim 1, wherein a threaded hole is defined in one side of the driven base to be screwed onto a threaded stub on the threaded drive rod.

3. The driving device as claimed in claim 1, wherein multiple threaded holes are defined through the driving base;
a blind hole is defined in the driven base and aligns with each threaded hole in the driving base; and
a bolt is screwed into each threaded hole in the driving base and extends into the aligned blind hole in the driven base to connect the driven base to the driving base.

4. The driving device as claimed in claim 3, wherein a shock absorber is received in each blind hole in the driven base and encloses the bolt mounted in the blind hole to absorb vibrations occurring between the driving base and the driven base.

5. The driving device as claimed in claim 1, wherein a shoulder with an outer diameter larger than that of the driving base is formed on one end of the driving base to hold the magnet in position.

6. The driving device as claimed in claim 1, wherein an annular groove is defined around an inner surface of the housing; and
a fastener is mounted in the groove to abut one end of the positioning base to firmly hold the positioning base.

7. The driving device as claimed in claim 1, wherein multiple longitudinal keyways are defined in an outer periphery of the positioning base; and
a longitudinal key corresponding to each groove in the positioning base is defined on an inner surface of the housing to engage with each keyway in the base.

8. The driving device as claimed in claim 1, wherein a central hole is defined through the positioning base to receive the shaft connector; and
a bearing is received in the central hole of the positioning base to engage with the driven base of the shaft connector,
whereby the shaft connector can rotate freely relative to the positioning base.

9. The driving device as claimed in claim 8, wherein at least one blind hole is defined in a side of the positioning base facing the motor;
a post protrudes from the motor and extends into each blind hole in the positioning base; and
a shock absorber is received in each blind hole in the positioning base and encloses the post extending into the blind hole to absorb vibrations generated by the motor.

10. The driving device as claimed in claim 9, wherein a flat shock absorber is attached to the motor and abuts the positioning base to absorb vibrations generated by the motor.
